(19) United States
(12) Patent Application Publication
(10) Pub. No.: US 2010/0202050 A1
(43) Pub. Date: Aug. 12, 2010

(54) OPTICAL FILM AND METHOD OF MANUFACTURING THE SAME

(75) Inventors: Byoung-II Kang, Daejeon Metropolitan City (KR); Chang-Hun Han, Daejeon Metropolitan City (KR); Dae-Woo Lee, Busan Metropolitan City (KR); Jae-Bum Seo, Jeollanam-do (KR); Jung-A Yoo, Daejeon Metropolitan City (KR); Song-Taek Oh, Daejeon Metropolitan City (KR)

Correspondence Address: MCKENNA LONG & ALDRIDGE LLP, 1900 K STREET, NW, WASHINGTON, DC, 20006, US

(73) Assignee: LG CHEM, LTD., Seoul (KR)

(21) Appl. No.: 12/678,968

(22) PCT Filed: Sep. 19, 2008
(86) PCT No.: PCT/KR2008/005551

§ 371 Date: Mar. 18, 2010

(30) Foreign Application Priority Data
Sep. 21, 2007 (KR) 10-2007-0096477

(51) Int. Cl. G02B 1/08; C08L 51/00

(52) U.S. Cl. 359/500; 525/80; 525/77; 525/74

(57) ABSTRACT

The present invention provides an optical film that includes i) an acryl resin, and ii) 20 to 65 parts by weight of a core-shell type graft copolymer that includes a core having a rubber component and a shell including a polymer having a weight average molecular weight that is the same as or higher than a weight average molecular weight of a polymer constituting the i) acryl resin based on 100 parts by weight of the acryl resin, a retardation film, and an electronic device including the same.

### TECHNICAL FIELD

The present invention relates to an optical film, and a method of manufacturing the same. More particularly, the present invention relates to an optical film that has excellent toughness so that the film is not broken even if the film is folded by hands and no increase in thermal expansion coefficient caused by an additive and no or little reduction in glass transition temperature (Tg) of an entire resin, and a method of manufacturing the same. The optical film may be usefully applied to an electronic device such as display devices including LCDs. This application claims priority from Korean Patent Application No. 10-2007-0096477 filed on Sep. 21, 2007 in the Korean Intellectual Property Office, the disclosure of which is incorporated herein by reference in its entirety.

### BACKGROUND ART

In recent years, in accordance with the advance in optical technology, various types of display technologies such as plasma display panels (PDP), liquid crystal displays (LCD), organic/inorganic EL displays (ELD) and the like have been suggested and sold in the market instead of a known cathode-ray tube. In the above-mentioned displays, the use of various types of plastic films has been suggested and the required characteristics thereof have been sophisticated. For example, in the case of the liquid crystal displays, in order to obtain the slimness and the lightness and to improve display characteristics, various types of plastic films are used in a polarizing plate, a retardation film, a plastic substrate, a light guide plate.

Currently, in accordance with development of a flexible device, it is required that the film has excellent toughness. An effort has been made to add an impact buffering material in order to improve the toughness of the film. However, in the case of when the impact buffering material is added to the film, the toughness may be improved, but there are problems in that the heat resistance is significantly reduced to rapidly increase the thermal expansion coefficient and the glass transition temperature of the entire film is reduced.

### DISCLOSURE OF INVENTION

### Technical Problem

The present invention has been made keeping in mind the problems occurring in the related art, and an object of the present invention is to provide an optical film that has excellent toughness and no increase in thermal expansion coefficient caused by an additive and no or little reduction in glass transition temperature (Tg) of an entire resin, and a method of manufacturing the same. It is another object of the present invention to provide a retardation film that is manufactured by using the optical film and a method of manufacturing the same. It is still another object of the present invention to provide an electronic device that includes the optical film or retardation film.

### Technical Solution

The present invention provides an optical film that comprises i) 100 parts by weight of an acryl resin, and ii) 20 to 65 parts by weight of a core-shell type graft copolymer that comprises a core having a rubber component and a shell including a polymer having a weight average molecular weight that is the same as or higher than a weight average molecular weight of a polymer constituting the i) acryl resin based on 100 parts by weight of the acryl resin.

In addition, the present invention provides a method of manufacturing an optical film, which comprises a) preparing a resin composition that comprises i) an acryl resin, and ii) 20 to 65 parts by weight of a core-shell type graft copolymer that comprises a core having a rubber component and a shell including a polymer having a weight average molecular weight that is the same as or higher than a weight average molecular weight of a polymer constituting the i) acryl resin based on 100 parts by weight of the acryl resin, and b) forming a film by using the resin composition.

In addition, the present invention provides a retardation film that is manufactured by stretching the optical film.

In addition, the present invention provides a method of manufacturing a retardation film, which comprises a) preparing a resin composition that comprises i) an acryl resin, and ii) 20 to 65 parts by weight of a core-shell type graft copolymer that comprises a core having a rubber component and a shell including a polymer having a weight average molecular weight that is the same as or higher than a weight average molecular weight of a polymer constituting the i) acryl resin based on 100 parts by weight of the acryl resin, b) forming a film by using the resin composition, and c) uniaxially or biaxially stretching the film.

In addition, the present invention provides an electronic device that comprises the optical film or the retardation film.

### Advantageous Effects

An optical film according to the present invention has the excellent toughness and no increase in thermal expansion coefficient caused by addition of a core-shell type graft copolymer including a rubber component and no or little reduction in glass transition temperature (Tg) of an entire resin. Accordingly, the optical film can be used instead of a known costly TAC resin, and may be usefully applied to an electronic device such as image display devices including LCDs.

### BEST MODE FOR CARRYING OUT THE INVENTION

Hereinafter, the present invention will be described in detail.

An optical film according to the present invention comprises an acryl resin that acts as a matrix and a core-shell type graft copolymer that is used as an impact buffering material, a core of the graft copolymer includes a rubber component, and a weight average molecular weight of a polymer constituting a shell is the same as or higher than a weight average molecular weight of a polymer constituting the acryl resin acting as the matrix.

In the related art, in the case of when an impact buffering material is added to a film, the toughness is improved, but there are problems in that the CTE that is a thermal expansion coefficient is rapidly increased and a glass transition temperature of an entire resin is reduced. However, in the present invention, the toughness of the optical film is improved by adding the core-shell type graft copolymer including the rubber component, and the molecular weight of the polymer that constitutes the shell of the core-shell type impact buffering material is the same as or higher than that of the polymer that constitutes the matrix resin. Accordingly, an increase in the thermal expansion coefficient is slight and the glass transition temperature of the entire resin is hardly reduced.

In the present invention, the core of the core-shell type graft copolymer includes the rubber component. Examples of the rubber component are not limited, but may includes a conjugated diene rubber and the like.

Examples of the conjugated diene rubber component may include an ethylene-propylene diene rubber, a butadiene rubber and the like, and it is more preferable to use the butadiene rubber. The conjugated diene rubber component is included in an amount of 10 to 50 parts by weight and preferably 15 to 45 parts by weight based on 100 parts by weight of the graft copolymer.

In the present invention, the shell of the core-shell type graft copolymer has the weight average molecular weight that is the same as or higher than that of the polymer constituting the acryl resin that acts as the matrix. It is preferable that the weight average molecular weight of the polymer constituting the shell be in the range of 120000 to 180000. Due to these characteristics, the impact effect can be maximized and the reduction in glass transition temperature of the entire resin to which the graft copolymer is added can be minimized.

It is preferable that the graft ratio be in the range of 30 to 60% during the manufacturing of the graft copolymer.

A component that is known in the art may be used as a component of the shell of the graft copolymer. For example, examples of the acryl resin are not limited, but may include a homo or copolymer of the acryl monomer; a copolymer of an acryl monomer and an aromatic vinyl monomer; a copolymer of an acryl monomer, an aromatic vinyl monomer and an acrylonitrile monomer; a copolymer of an acryl monomer, an aromatic vinyl monomer and an acid anhydride; a copolymer of an acryl monomer, an aromatic vinyl monomer, an acrylonitrile monomer and an acid anhydride and the like.

A compound which has a double bond between a carbonyl group of an ester group and conjugated carbons may be used as the acryl monomer, and examples of a substituent group thereof is not limited. The acryl monomer that is described in the present specification includes acrylate and an acrylate derivative, and is a notion including alkyl acrylate, alkyl methacrylate, alkyl butacrylate and the like. For example, examples of the acryl monomer include a compound that is represented by the following Formula 1.

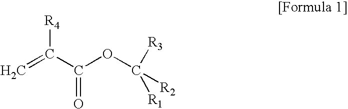

wherein R₁, R₂ and R₃ are each independently a hydrogen atom, or a monovalent hydrocarbon group that includes or not a hetero atom and has 1 to 30 carbon atoms, at least one of R₁, R₂ and R₃ may be an epoxy group, and R₄ is a hydrogen atom or analkyl group having 1 to 6 carbon atoms.

Specific examples of the acryl monomer may include one or more acryl monomers selected from the group consisting of methyl acrylate, ethyl acrylate, methyl methacrylate, ethyl methacrylate, methyl ethacrylate, and ethyl ethacrylate, and in particular, it is most preferable to use methyl methacrylate (MMA).

It is preferable that a monomer having a structure in which a benzene nucleus is substituted or unsubstituted with one or more C₁ to C₅ alkyl groups or halogen groups be used as the aromatic vinyl monomer. For example, it is preferable that one or more styrene monomers selected from the group consisting of styrene or α-methyl styrene, p-methyl styrene, vinyl toluene be used.

Preferable examples of the acrylonitrile monomer include one or more acrylonitrile monomers selected from the group consisting of acrylonitrile, methaacrylonitrile, and ethaacrylonitrile.

The carboxylic acid anhydride may be used as the acid anhydride, and monovalent or polyvalent carboxylic acid anhydride including divalanet carboxylic acid anhydride may be used. Preferably, maleic acid anhydride or a derivative thereof may be used, and for example, a compound that is represented by the following Formula 2 may be used.

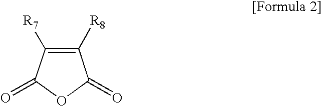

wherein R₇ and R₈ are each independently hydrogen atom or analkyl group having 1 to 6 carbon atoms.

In the present invention, among the graft copolymers, in the case of when a copolymer of the acryl monomer, the aromatic vinyl monomer, and the acrylonitrile monomer, or a copolymer of the acryl monomer, the aromatic vinyl monomer and the acid anhydride as the acryl resin, is preferable that the weight ratio be in the range of 55 to 80:10 to 35:4 to 15.

The conjugated diene rubber component and the acryl resin may be subjected to graft polymerization by using a method that is known in the art, and for example, a general emulsification polymerization method may be used. It is preferable that the graft ratio be in the range of 30 to 60%. If the graft ratio is less than 30%, the haze may be increased due to the stretching of the final film, and if the graft ratio is more than 60%, it is difficult to manufacture the film in views of the process. The particle size of the core including the conjugated diene rubber component is in the range of preferably 150 to 400 nm and more preferably 200 to 300 nm, but the scope of the present invention is not limited thereto.

It is preferable that in the optical film according to the present invention, the graft copolymer be included in an amount of 20 to 65 parts by weight based on 100 parts by weight of the acryl resin acting as the matrix.

In the present invention, a substance that is known in the art may be used as the acryl resin that acts as the matrix of the optical film. In particular, it is preferable to use a homo or copolymer of the acryl monomer; a copolymer of the acryl monomer and the aromatic vinyl monomer; a copolymer of the acryl monomer, the aromatic vinyl monomer and the acrylonitrile monomer; a copolymer of the acryl monomer, the aromatic vinyl monomer and the acid anhydride; or a copolymer of the acryl monomer, the aromatic vinyl monomer, the acrylonitrile monomer and the acid anhydride. It is more preferable to use the copolymer of the acryl monomer, the aromatic vinyl monomer and the acrylonitrile monomer; the copolymer of the acryl monomer, the aromatic vinyl monomer and the acid anhydride; or the copolymer of the acryl monomer, the aromatic vinyl monomer, the acrylonitrile monomer and the acid anhydride.

In the case of when the copolymer of the acryl monomer, the aromatic vinyl monomer and the acrylonitrile monomer or the copolymer of the acryl monomer, the aromatic vinyl monomer and the acid anhydride is used as the matrix resin, it is preferable that the weight ratio of each of the monomers be in the range of 55 to 80:10 to 35:4 to 15. Examples of the monomers are the same as those of the components that are described in respects to the acryl resin among the graft copolymers. The acryl monomer may contribute to optical properties, the aromatic vinyl monomer may contribute to the formability and the retardation provision of the film, and the acrylonitrile monomer and the acid anhydride may contribute to the heat resistance. The matrix resin may be polymerized by using the method that is known in the art, and for example, the bulk polymerization method may be used.

The copolymer that constitutes the acryl resin acting as the matrix may further include one or more monomers selected from the (meth)acrylic acid and imide monomers as an additional comonomer. The acrylic acid and methacrylic acid or a derivative thereof may be used as the (meth)acrylic acid. The phenyl maleimide, cyclohexyl maleimide and the like may be used as the imide monomer. In the case of when the (meth)acrylic acid and imide monomers are included, it is preferable that the amount be 15 parts by weight or less based on 100 parts by weight of the copolymer.

The above-mentioned matrix resin is characterized in that the glass transition temperature is in the range of 120 to 130° C., the molecular weight is in the range of 120000 to 150000, the MI (220° C., 10 kg) is 10 or less, and preferably 4 to 10, and the haze is in the range of 0.1 to 2%. The MI is an index that illustrates the flow of the resin and means an amount of the resin per minute when a load of 10 kg is applied at 220° C. In addition, the matrix resin has the refractive index in the range of preferably 1.48 to 1.545 and more preferably 1.485 to 1.535 in order to obtain the transparency required in the optical film.

The optical film according to the present invention may be manufactured by forming a film using the resin composition including the graft copolymer and the acryl resin.

The method of forming the film may be performed by using a method that is known in the art. The optical film according to the present invention may be manufactured by an extrusion process in addition to a casting process unlike the film that is made of the acryl resin.

In order to manufacture the optical film, a general additive, for example, a plasticizer, a lubricant, an impact buffering material, a stabilizing agent, a ultraviolet ray absorption agent and the like, may be added to the resin composition. In particular, in the case of when the optical film according to the present invention is used as a protective film of a polarizer, in order to protect the polarizer and the liquid crystal panel from the external ultraviolet rays, it is preferable to add the ultraviolet ray absorbing agent to the resin composition. Examples of ultraviolet ray absorbing agent may include, but are not limited to a benzotriazole ultraviolet ray absorbing agent and a triazine ultraviolet ray absorbing agent, and a hindered amine light stabilizer such as bis(2,2,6,6-tetramethyl-4-piperidyl) sebaceate may be used. Preferably, Tinuvin328, Tinuvin321 and Tinuvin 360 may be used. Igafos 168, Iganox 1076, and Iganox 245 may be added as the thermal stabilizing agent.

The thickness of the optical film according to the present invention may be in the range of 20 to 200 μm, and preferably 40 to 120 μm. In the optical film according to the present invention, a glass transition temperature is in the range of 110 to 130° C., a thermal deformation temperature (Vicat) is in the range of 110 to 140° C., an MI (220° C., 10 kg) is in the range of 2 to 6, and the toughness is excellent. In addition, the case of the optical film according to the present invention, preferably, a thermal expansion coefficient CTE (ppm/K, 40 to 90° C.) is in the range of 50 to 120, a haze is in the range of 0.5 to 3%, and a transmittance is in the range of 88 to 93%.

In the optical film according to the present invention, an in-plane retardation value and a thickness retardation value may be in the range of 0 to 10 nm before the stretching and in the case of when the film is uniaxially or biaxially stretched, the in-plane retardation value and the thickness retardation value may be in the range of 80 to 200 nm.

The stretching process of the optical isotropic film is performed at a temperature range of preferably Tg−30° C. to Tg+30° C. and more preferably Tg−10° C. to Tg+20° C. based on the glass transition temperature (Tg) of the resin composition. In addition, the stretching speed and the stretching ratio may be appropriately controlled in the range capable of achieving the object of the present invention.

The optical film according to the present invention may be used as a polarizer protective film. In this case, the surface may be reformed in order to improve the adhesion strength. Examples of the reforming method comprise a method of treating a surface of the protective film by using corona treatment, plasma treatment, and UV treatment, and a method of forming a primer layer on the surface of the protective film. Both the methods may be used simultaneously. The type of the primer is not limited, but it is preferable to use the compound having the reactive functional group such as a silnae coupling agent.

The polarizing plate that comprise the optical film according to the present invention as the protective film comprise a polarizer and a protective film provided on at least one side of the polarizer, and at least one of the protective films may have a structure that is the optical film according to the present invention.

In the present invention, any polarizer may be used as long as the polarizer is known in the art, and for example, a film which contains iodine or dichromatic dyes and is made of polyvinyl alcohol (PVA) may be used. The polarizer may be produced by applying iodine or dichromatic dyes on the PVA film. However, the production method of the polarizing plate is not limited. In the specification, the polarizer does not comprise the protective film, and the polarizing plate comprises the polarizer and the protective film.

The adhesion of the polarizer and the protective film may be performed by using an adhesive layer. Examples of the adhesive which is capable of being used to combine the protective film and the polarizing plate are not limited as long as the adhesive is known in the art. Examples of the adhesive include, but are not limited to a one- or two-liquid type polyvinyl alcohol (PVA) adhesive, a polyurethane adhesive, an epoxy adhesive, a styrene-butadiene rubber (SBR) adhesive, a hot melt adhesive and the like.

Among the adhesives, it is preferable to use a polyvinyl alcohol adhesive. In particular, it is preferable to use the adhesive that includes the polyvinyl alcohol resin having the acetacetyl group and the amine metal compound crosslinking agent. The adhesive for the polarizing plate may include 100 parts by weight of the polyvinyl alcohol resin having the acetacetyl group and the 1 to 50 parts by weight of the the amine metal compound crosslinking agent.

The polyvinyl alcohol resin is not limited as long as the resin is capable of desirably attaching the polarizer and the protective film to each other, and has excellent optical penetration and no consecutive change such as yellowing. In consideration of the desirable crosslinking reaction to the crosslinking agent, it is preferable to use the polyvinyl alcohol resin containing the acetacetyl group.

The degree of polymerization and saponification of the polyvinyl alcohol resin are not limited as long as the polyvinyl alcohol resin contains the acetacetyl group, but it is preferable that the degree of polymerization be 200 to 4,000 and the degree of saponification be 70 to 99.9 mol %. In consideration of the desirable mixing to the contained material according to the free movement of molecules, it is more preferable that the degree of polymerization is 1,500 to 2,500 and the degree of saponification is 90 to 99.9 mol %. In connection with this, it is preferable that the polyvinyl alcohol resin contain 0.1 to 30 mol % of acetacetyl group. In the above-mentioned range, the reaction to the crosslinking agent may be desirably performed and the adhesive may have the desired waterproofing property and adhesion strength.

The amine metal compound crosslinking agent is a water-soluble crosslinking agent that contains a functional group having a reactivity to the polyvinyl alcohol resin, and preferably, a metal complex containing an amine ligand. Examples of metal that is capable of being applied to the metal complex include a transition metal such as zirconium (Zr), titanium (Ti), hafnium (Hf), tungsten (W), iron (Fe), cobalt (Co), nickel (Ni), ruthenium (Ru), osmium (Os), rhodium (Rh), iridium (Ir), palladium (Pd), and platinum (Pt). Examples of the ligand that is coupled with the central metal may include any ligand as long as the ligand contains at least one amine group such as primary amines, secondary amines (diamines), tertiary amines, or ammonium hydroxides. It is preferable that the amount of the crosslinking agent be 1 to 50 parts by weight based on 100 parts by weight of polyvinyl alcohol resin. In the above-mentioned range, it is possible to provide significant adhesion strength to the target adhesive and to improve the storage stability (pot life) of the adhesive.

It is preferable that the pH of the adhesive aqueous solution including the polyvinyl alcohol resin containing the acetacetyl group and the amine metal compound crosslinking agent be controlled to 9 or less using a pH controlling agent. More preferably, the pH may be controlled to more than 2 and 9 or less, and even more preferably, 4 to 8.5.

The combination of the polarizer and the protective film may be performed according to an attachment method using an adhesive. That is, the adhesive is applied on the surface of the PVA film that is the protective film of the polarizer or the polarizer by using a roll water, a gravure water, a bar water, a knife water, a capillary water, or the like. Before the adhesive is completely dried, the protective film and the polarizing film are combined with each other using heat pressing or pressing at normal temperature by means of a combination roll. When a hot melt type adhesive is used, the heat pressing roll is used.

If the polyurethane adhesive is to be used, it is preferable to use the polyurethane adhesive produced by using an aliphatic isocyanate compound which does not cause yellowing due to light. If an one- or two-liquid type dry laminate adhesive or an adhesive having relatively low reactivity in respects to isocyanate and a hydroxy group is used, a solution type adhesive which is diluted with an acetate solvent, a ketone solvent, an ether solvent, or an aromatic solvent may be used. In this connection, it is preferable that the adhesive have low viscosity of 5000 cps or less. Preferably, the adhesive has excellent storage stability and light transmittance of 90% or more at a wavelength of 400 to 800 nm.

If showing sufficient tackifying power, a tackifier may be used for the lamination of the protective film and the polarizing film. If used, a tackifier is preferably heat- or UV-cure sufficiently to show resulting mechanical strength as high as that obtained with an adhesive. Also, the interface adhesion of the tackifier useful in the present invention is large enough so that delamination is possible only when one of the films bonded to each other therethrough is destroyed.

Specific examples of the tackifier may include natural rubber, synthetic rubber, or elastomer, a vinyl chloride/vinyl acetate copolymer, polyvinyl alkyl ether, polyacrylate, modified polyolefin adhesive having excellent optical transparency, and a curable tackifier containing a curing agent such as isocyanate.

The manufactured polarizing plate may be used for the various purposes. Specifically, the polarizing plate may be preferably applied to an image display device such as a polarizing plate for liquid crystal displays (LCD) and a polarizing plate for preventing the reflection of the organic EL display device. In addition, the optical film according to the present invention may be applied to a complex polarizing plate in which various optical layers such as various types of functional layers, for example, a retardation plate such as a λ/4 plate and a λ/2 plate, an optical diffusion plate, a viewing angle enlargement plate, a luminance improvement plate, and a reflection plate are combined with each other.

The polarizing plate may comprise an tackifier layer on at least one side thereof so as to be easily applied to image display devices and the like. In addition, the polarizing plate may further comprise a release film on the tackifier layer in order to protect the tackifier layer until the polarizing plate is applied to an image display device.

In addition, the present invention provides an electronic device that comprises the optical film or the retardation film. The electronic device may be an image display device such as LCDs. For example, the present invention provides an image display device that comprises a light source, a first polarizing plate, a liquid crystal cell, and a second polarizing plate sequentially layered, and also comprises the optical film or the retardation film according to the present invention as at least one protective film of the first polarizing plate and the second polarizing plate or the retardation film that is provided between at least one of the first polarizing plate and the second polarizing plate and the liquid crystal cell.

The liquid crystal cell comprises a liquid crystal layer; a substrate that is capable of supporting the liquid crystal layer; and an electrode layer to apply voltage to the liquid crystal. At this time, the optical film or the retardation film according to the present invention may be applied to a liquid crystal mode such as an In-Plane Switching mode (IPS mode), a Vertically Aligned mode (VA mode), an OCB mode (Optically Compensated Birefringence mode), a Twisted Nematic mode (TN mode), and a Fringe Field Switching mode (FFS mode).

### Mode for the Invention

A better understanding of the present invention may be obtained in light of the following Examples which are set forth to illustrate, but are not to be construed to limit the present invention.

### Example 1

The resin composition that included 80% by weight of the matrix resin in which the ratio of SM-MMA-MAH (styrene-methyl methacrylate-maleic anhydride) was 23:70:7% by weight and the weight average molecular weight was 130000, and 20% by weight of the impact buffering material that had the shell molecular weight of 130000 except for the rubber and the graft ratio of the core and the shell that was 40% was subjected to dry blending to manufacture the heat resistant blend pellet by using the unidirectional two-axis extrusion device. After the manufactured pellet was dried, the extruded film having the thickness of 80 μm was manufactured by using the extrusion device including the T-die. The physical properties of the manufactured film were measured, and the results are described in the following Table 1.

### Example 2

The physical properties of the film were measured by using the same method as that of Example 1, except that the resin composition that included 80% by weight of the matrix resin in which the ratio of SM-MMA-MAH (styrene-methyl methacrylate-maleic anhydride) was 23:70:7% by weight and the weight average molecular weight was 130000, and 20% by weight of the impact buffering material that had the shell molecular weight of 130000 except for the rubber and the graft ratio of the core and shell that was 50% was used, and the results are described in the following Table 1.

### Example 3

The physical properties of the film were measured by using the same method as that of Example 1, except that the resin composition that included 80% by weight of the matrix resin in which the ratio of SM-MMA-MAH (styrene-methyl methacrylate-maleic anhydride) was 23:70:7% by weight and the weight average molecular weight was 130000, and 20% by weight of the impact buffering material that had the shell molecular weight of 160000 except for the rubber and the graft ratio of the core and shell that was 45% was used, and the results are described in the following Table 1.

### Example 4

The physical properties of the film were measured by using the same method as that of Example 1, except that the resin composition that included 70% by weight of the matrix resin in which the ratio of SM-MMA-MAH (styrene-methyl methacrylate-maleic anhydride) was 23:70:7% by weight and the weight average molecular weight was 130000, and 30% by weight of the impact buffering material that had the shell molecular weight of 160000 except for the rubber and the graft ratio of the core and shell that was 45% was used, and the results are described in the following Table 1.

### Example 5

The physical properties of the film were measured by using the same method as that of Example 1, except that the resin composition that included 80% by weight of the matrix resin in which the ratio of SM-MMA-MAH (styrene-methyl methacrylate-maleic anhydride) was 23:70:7% by weight and the weight average molecular weight was 130000, and 20% by weight of the impact buffering material that had the shell molecular weight of 130000 except for the rubber and the graft ratio of the core and shell that was 28% was used, and the results are described in the following Table 1.

### Comparative Example 1

The physical properties of the film were measured by using the same method as that of Example 1, except that the resin composition that included 80% by weight of the matrix resin in which the ratio of SM-MMA-MAH (styrene-methyl methacrylate-maleic anhydride) was 23:70:7% by weight and the weight average molecular weight was 130000, and 20% by weight of the impact buffering material that had the shell molecular weight of 90000 except for the rubber and the graft ratio of the core and shell that was 45% was used, and the results are described in the following Table 1.

### Comparative Example 2

The physical properties of the film were measured by using the same method as that of Example 1, except that the resin composition that included 90% by weight of the matrix resin in which the ratio of SM-MMA-MAH (styrene-methyl methacrylate-maleic anhydride) was 23:70:7% by weight and the weight average molecular weight was 130000, and 10% by weight of the impact buffering material that had the shell molecular weight of 130000 except for the rubber and the graft ratio of the core and shell that was 50% was used, and the results are described in the following Table 1.

### Comparative Example 3

The physical properties of the unstretched TAC film (thickness 80 μm, Fuji film) were measured by using the same method as Example 1, and the results are described in the following Table 1.

TABLE 1

| | | | | | | Comparative | Comparative | Comparative |
|---|---|---|---|---|---|---|---|---|
| | Example 1 | Example 2 | Example 3 | Example 4 | Example 5 | Example 1 | Example 2 | Example 3 |
| Tg (° C.) | 125 | 125 | 127 | 123 | 118 | 114 | 125 | 135 |
| Haze (%) | 0.8 | 0.6 | 0.8 | 1.2 | 2.7 | 0.9 | 0.4 | 0.4 |
| Toughness | ◯ | ◯ | ◯ | ◯ | ◯ | ◯ | X | ◯ |
| Straight | 90 | 91 | 90 | 88 | 84 | 90 | 92 | 92 |
| transmittance (%) | | | | | | | | |

| | | | | | | | | | |
|---|---|---|---|---|---|---|---|---|---|
| Retardation | Rᵢₙ | 1 | 1 | 1 | 1 | 2 | 3 | 1 | 1 |
| before | | | | | | | | | |
| stretching | | | | | | | | | |
| | Rₜₕ | 7 | 8 | 7 | 9 | 8 | 9 | 4 | −50 |
| Retardation | Rᵢₙ | 150 | 145 | 147 | 130 | 115 | 120 | 140 | |
| after | | | | | | | | | |
| stretching | | | | | | | | | |
| | Rₜₕ | 150 | 150 | 150 | 135 | 117 | 120 | 147 | |

| | | | | | | | | |
|---|---|---|---|---|---|---|---|---|
| Thermal expansion | 80 | 78 | 80 | 85 | 150 | 130 | 75 | 40 |
| coefficient (CTE) | | | | | | | | |

(1) Measurement of the haze and the straight transmissivity - The measurement was performed by using the ASTM 1003 method.
(2) Toughness - The measurement was performed by folding using hands the film having the thickness of 80 μm ten times to check the breaking (◯: No breaking, Δ: the breaking occurs one to three times, and X: the breaking occurs four or more times).
(3) Tg (glass transition temperature) - The measurement was performed by using Pyris 6 DSC (Differential Scanning Calroimeter) that was manufactured by Perkin Elmer, Inc.
(4) Retardation - The refractive index was measured by using the Abbe refractometer and the calculation was performed by using the sample-gradient type automatic double refraction device according to the following Equations. Rᵢₙ = d × (nₓ − n_{y}) Rₜₕ = d × (n_{z} − n_{y}) (wherein, d is the thickness of the film, nₓ is the x-axis direction refractive index of the in-plane refractive index, n_{y} is the y-axis direction refractive index of the in-plane refractive index, and n_{z} is the thickness direction refractive index)
(5) Thermal expansion coefficient (CTE) - The measurement was performed while the temperature of the film was increased by using the DMA device.

1. An optical film comprising:
i) an acryl resin; and
ii) 20 to 65 parts by weight of a core-shell type graft copolymer that comprises a core having a rubber component and a shell including a polymer having a weight average molecular weight that is the same as or higher than a weight average molecular weight of a polymer constituting the i) acryl resin based on 100 parts by weight of the i) acryl resin.

2. The optical film as set forth in claim 1, wherein a graft ratio of the graft copolymer is in the range of 30 to 60%.

3. The optical film as set forth in claim 1, wherein a glass transition temperature is in the range of 110 to 130° C., a thermal deformation temperature (Vicat (° C.)) is in the range of 110 to 140° C., an MI (220° C.) is in the range of 2 to 6, a thermal expansion coefficient CTE (ppm/K, 40 to 90° C.) is in the range of 50 to 120, a haze is in the range of 0.5 to 3%, and a transmittance is in the range of 88 to 93%.

4. The optical film as set forth in claim 1, wherein an in-plane retardation and a thickness retardation are in the range of 0 to 10 nm.

5. The optical film as set forth in claim 1, wherein i) the acryl resin includes one or more selected from the group consisting of a homo or copolymer of the acryl monomer; a copolymer of an acryl monomer and an aromatic vinyl monomer; a copolymer of an acryl monomer, an aromatic vinyl monomer and an acrylonitrile monomer; a copolymer of an acryl monomer, an aromatic vinyl monomer and an acid anhydride; and a copolymer of an acryl monomer, an aromatic vinyl monomer, an acrylonitrile monomer and an acid anhydride.

6. The optical film as set forth in claim 5, wherein the polymer that constitutes the acryl resin further includes one or more monomers of (meth)acrylic acid and imide monomers as a comonomer.

7. The optical film as set forth in claim 1, wherein the core of ii) the graft copolymer includes a conjugated diene rubber.

8. The optical film as set forth in claim 7, wherein the core of ii) the graft copolymer includes one or more selected from the group consisting of an ethylene-propylene diene rubber and a butadiene rubber.

9. The optical film as set forth in claim 1, wherein the weight average molecular weight of the shell of ii) the graft copolymer is in the range of 120000 to 180000.

10. The optical film as set forth in claim 1, wherein the shell of ii) the graft copolymer includes the acryl resin.

11. The optical film as set forth in claim 10, wherein the shell of ii) the graft copolymer includes one or more selected from the group consisting of a homo or copolymer of the acryl monomer; a copolymer of an acryl monomer and an aromatic vinyl monomer; a copolymer of an acryl monomer, an aromatic vinyl monomer and an acrylonitrile monomer; a copolymer of an acryl monomer, an aromatic vinyl monomer and an acid anhydride; and a copolymer of an acryl monomer, an aromatic vinyl monomer, an acrylonitrile monomer and an acid anhydride.

12. A method of manufacturing an optical film, the method comprising:
a) preparing a resin composition that includes i) an acryl resin, and ii) 20 to 65 parts by weight of a core-shell type graft copolymer that includes a core having a rubber component and a shell including a polymer having a weight average molecular weight that is the same as or higher than a weight average molecular weight of a polymer constituting the i) acryl resin based on 100 parts by weight of the acryl resin; and
b) forming a film by using the resin composition.

13. The method of manufacturing an optical film as set forth in claim 12, wherein a graft ratio of the graft copolymer is in the range of 30 to 60%.

14. A retardation film that is manufactured by stretching the optical film according to claim 1.

15. The retardation film as set forth in claim 14, wherein an in-plane retardation and a thickness retardation are in the range of 80 to 200 nm.

16. A polarizing plate comprising:
a polarizer; and
protective films that are provided at least one side of the polarizer,
wherein at least one of the protective films is the optical film according to claim 1.

17. An electronic device comprising:
the optical film according to claim 1.

18. An electronic device comprising:
the retardation film according to claim 14.

19. An electronic device comprising:
the polarizing plate according to claim 16.
